(19) United States
(12) Patent Application Publication
(10) Pub. No.: US 2013/0104673 A1
(43) Pub. Date: May 2, 2013

(54) AUTOMATIC SAMPLER FOR GRANULATION COATING APPARATUS

(71) Applicant: FREUND CORPORATION, Tokyo (JP)

(72) Inventors: Shigemi ISOBE, Tokyo (JP); Yuriko HIRAI, Tokyo (JP)

(73) Assignee: FREUND CORPORATION, Tokyo (JP)

(21) Appl. No.: 13/660,272

(22) Filed: Oct. 25, 2012

(30) Foreign Application Priority Data
Oct. 28, 2011 (JP) 2011-236813

(51) Int. Cl. G01N 1/08

(52) U.S. Cl. CPC G01N 1/08
USPC 73/863.01

(57) ABSTRACT

In a pan coating apparatus provided with a rotating drum, a sampling portion is provided at a leading end portion of a sampling pipe extending inside and outside the rotating drum. The sampling portion swings between a pickup position A and a suction position D within the drum. The sampling portion introduces objects to be processed in the sampling portion, and then the objects are scooped out while moving the sampling portion to the suction position B. Thereafter, the objects are sucked by an ejector and fed to a sample collecting portion.

### BACKGROUND OF THE INVENTION

1. Field of the Invention

The present invention relates to a sampler for granulation coating apparatus and, more particularly, to an automatic sampler installed in a pan coating apparatus provided with a rotating drum.

2. Related Art Statement

When processings such as granulation, coating, drying and mixing of powder and particle are performed, so-called “sampling” in which objects to be processed are collected where appropriate in the middle of the treatment processes is often performed so as to observe the finish of the objects. The sampling is performed for various purposes other than to observe the finish of the objects to correct treatment condition. For example, to predict an end-point of treatment, to grasp transition of physical properties of the objects occurring with progress of the treatment process, to perform analysis of the treatment process based on the grasped transition of the physical properties, and the like can be taken. For this reason, the sampling is regarded as one of important processes for obtaining a desired product.

However, the sampling operation has been manually conducted by an operator, which poses problems in terms of safety and health of the operator. Further, the manual sampling operation may cause contamination of the objects in the apparatus. Further, there may be a case where granulation and coating needs to be temporarily stopped for the sampling. Under such circumstances, a technique capable of automatically collecting a sample with safety and ease without need to stop and open the apparatus.

In view of this, the applicant has created an automatic sampler (Japanese Patent No. 3,115,305) provided with a sampling pipe, a depressurization source, a valve device, and the like to achieve safe automatic sample collection in a granulation coating apparatus. The sampler disclosed in Japanese Patent No. 3,115,305 is installed in, e.g., a fluidized bed granulation coating apparatus provided with a cylindrical processing vessel in which objects to be processed are accommodated. The sampler depressurizes the sampling pipe mounted to the processing vessel to suck powder and particle which are being subjected to granulation and coating to discharge the powder and particle outside the apparatus for collection through the sampling pipe. A separator is mounted to a suction end of the sampling pipe. This separator is used to perform gas-solid separation, and a sample which is solid is collected. Thus, the sampler disclosed in Japanese Patent No. 3,115,305 eliminates the need for an operator himself or herself to collect the sample. Further, sample collection can be accomplished without interruptions. Therefore, work efficiency of coating treatment can be improved.

In recent years, a granulation coating apparatus is demanded to meet containment requirements (containment of the objects to be processed) not only for achieving production under a clean environment, but also for prevention of contamination and prevention of exposure of operators. In achieving the containment requirements, if the apparatus has a small size, treatment can be conducted manually in an isolator. However, in a large-sized apparatus, the operator needs to wear protective clothing. Wearing of the protective clothing is troublesome and restricts movement of the operator, resulting in a reduction in work efficiency. In view of this, a system allowing even the large-sized apparatus to meet the containment requirements without forcing the operator to wear the protective clothing has been demanded.

In the sampler disclosed in Japanese Patent No. 3,115,305 or a sampler disclosed in Jap. Pat. Appln. Laid-Open Publication No. 2007-292753, the objects to be processed that have been sucked outside the granulation coating apparatus are subjected to gas-solid separation using the separator, so that air in the processing vessel is discharged outside the apparatus. In this case, the exhaust air is discharged outside the apparatus through a filter. However, in recent years, guidelines for exposure to (scattering of) the objects to be processed have become stricter. Thus, there may be a case where a structure in which the exhaust air is discharged outside the apparatus is not favorable. In particular, in a case where harmful substances are treated, contact between the operator and objects to be processed needs to be strictly avoided, thus requiring an apparatus capable of performing sampling in a closed system.

### SUMMARY OF THE INVENTION

An object of the present invention is to provide an automatic sampler capable of performing sampling of objects to be processed in an apparatus that performs processings such as granulation, coating, drying and mixing of powder and particle while maintaining its closed system.

According to the present invention, there is provided an automatic sampler for granulation coating apparatus mounted to a granulation coating apparatus that performs processings such as granulation, coating, drying and mixing of powder and particle in a processing vessel provided therein, the sampler including: a sampling pipe that has one end disposed in the processing vessel and the other end extending outside the processing vessel; a sampling portion that is formed at a leading end of the one end of the sampling pipe and moves in the processing vessel so as to pickup a sample of objects to be processed from a layer of the object to be processed of the powder and particle; a depressurization source that imparts sample suction action brought about by depressurization to the sampling pipe; a sample collecting portion that is provided between the other end of the sampling pipe and the depressurization source and accommodates the sample of the objects to be processed sucked from the sampling portion; and an air return pipe that has one end connected to the depressurization source and the other end communicating with an inside of the processing vessel and circulates exhaust air caused by the sample suction action into the processing vessel.

The automatic sampler according to the present invention has the sampling pipe extending inside and outside the processing vessel. The sampling portion capable of moving within the processing vessel is provided at the leading end of the sampling pipe. This sampling portion is used to pick up the objects to be processed in the processing vessel. The objects picked up by the sampling portion are sucked by suction action caused by the depressurization source and fed to the sample collecting portion. Exhaust air caused by the suction action is returned to the processing vessel through the air return pipe. The above configuration eliminates eliminating the need to manually collect the sample, thus making it possible to automatically perform the sampling of the objects to be processed in a closed system with safety and ease. Further, the sampling can be performed without interruption to thereby improve work efficiency of coating treatment.

In the automatic sampler, the sampling portion may be formed so as to be bent at the leading end of the sampling pipe and inclined relative to a horizontal axis. Further, the sampling portion may be formed so as to be able to swing, by rotation of the sampling pipe, between a pickup position at which the sampling portion is inserted into the layer of the object to be processed to introduce the objects in the sampling portion and a suction position at which the sampling portion is moved away from the layer and the introduced objects can be sucked to the sample collecting portion side. In this case, when moving from the pickup position to the suction position, the sampling portion may scoop out the objects in the layer and introduces them in the sampling portion.

Further, the sampling portion may have a cut-out portion obtained by cutting a peripheral wall of the sampling pipe and a trapping portion provided inside the cut-out portion so as to communicate with the inside of the sampling pipe. In this case, the objects may be introduced from the cut-out portion into the trapping portion to trap the sample of the objects.

The processing vessel may be a rotating drum provided so as to be able to rotate about substantially a horizontal rotating axis, and the present invention is suitably applied to so-called a pan coating apparatus. In addition, the sampling portion may be inclined by 8° to 12° relative to the horizontal axis, preferably 10°, and an aperture angle θ of the cut-out portion may be 80° to 100°, and preferably, 90°.

### BRIEF DESCRIPTION OF THE DRAWINGS

FIG. 1 is an explanatory view illustrating a configuration of a pan coating apparatus to which an automatic sampler according to an embodiment of the present invention is mounted;

FIG. 2 is an explanatory view illustrating a configuration of the automatic sampler;

FIG. 3 is an explanatory view illustrating operation of a sampling portion;

FIG. 4 is a perspective view illustrating a configuration of the sampling portion;

FIG. 5A is a side view of the sampling portion; and FIG. 5B is a front view of the sampling portion.

### DESCRIPTION OF THE PREFERRED EMBODIMENT

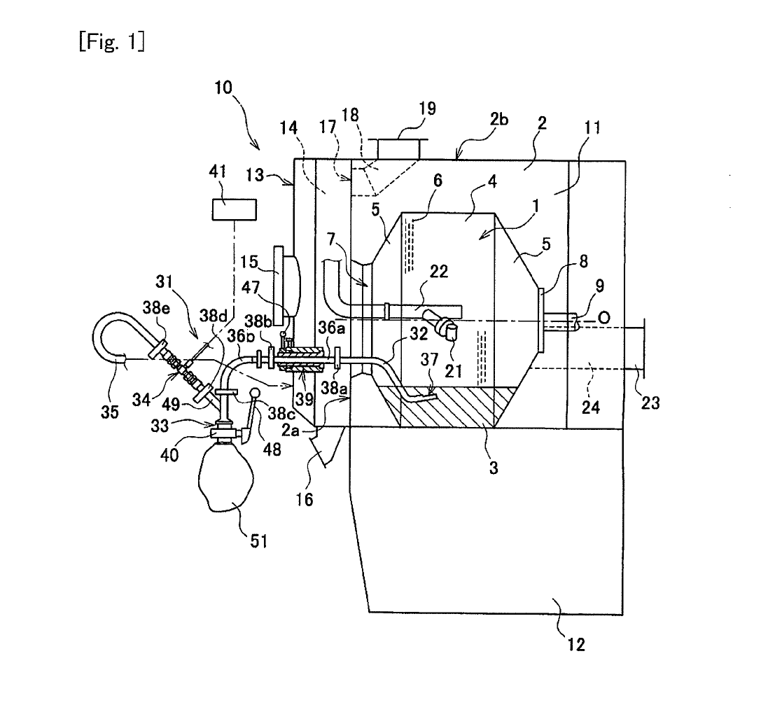

An embodiment of the present invention will be described in detail below with reference to the accompanying drawings. FIG. 1 is an explanatory view illustrating a configuration of a pan coating apparatus 10 (hereinafter, referred to merely as “coating apparatus 10”) to which an automatic sampler according to an embodiment of the present invention is mounted. The apparatus illustrated in FIG. 1 is a granulation coating apparatus that uses, as a processing vessel, a rotating drum having a punching structure on the whole surface. The coating apparatus 10 is of a jacketless type having no ventilation jacket. Objects to be processed such as tablets are accommodated in a rotating drum (coating pan, which is hereinafter referred to merely as “drum”) 1. The objects to be processed are subjected to coating by spraying coating liquid to the objects in the drum 1 which is being rotated.

As illustrated in FIG. 1, in the coating apparatus 10, the drum 1 is rotatably installed in a center of a casing 2. The drum 1 is rotated about substantially a horizontal rotating axis O. Objects to be processed 3 such as pieces of chewing gum, pieces of chocolates, or tablets are put into the drum 1. The drum 1 has a cylindrical trunk portion 4 and a conical portion 5 formed on both sides of the trunk portion 4. The conical portion 5 is formed in a truncated cone shape. The trunk portion 4 is formed of a porous stainless plate. A large number of ventilating holes 6 are formed in an outer peripheral surface of the trunk portion 4 for ventilation. The conical portion 5 is formed of a non-porous stainless plate. A front opening 7 is formed at one end side of the conical portion 5. The other end side of the conical portion 5 is closed by an end plate 8. A rotary shaft 9 is attached to the end plate 8.

In FIG. 1, a not-illustrated drum rotating mechanism is disposed at a right side of the drum 1. An electric drum drive motor is used for the drum rotating mechanism. The rotary shaft 9 is fixed to the right side (the other end side) of the drum 1 as described above. A not-illustrated sprocket is fitted to the rotary shaft 9. The sprocket of the rotary shaft 9 is connected to a motor-side sprocket installed in the casing 2 through a chain. On the other hand, a left side of the drum 1 in FIG. 1 is supported by a not-illustrated roller. Thus, as the motor rotates, the drum 1 is driven to rotate around the rotating axis O by the chain.

The casing 2 has a double structure in which the drum 1 is housed in a drum chamber 11. A sink 12 is provided at a lower portion of the drum chamber 11. The sink 12 has a watertight structure having a not-illustrated drain port at a bottom portion thereof. The sink 12 can store inside thereof washing liquid such as water. When the coating apparatus 10 is washed, the washing liquid is accumulated in the sink 12, and inside and outside of the drum 1 being rotated are washed in filled water. After the washing, the washing water is discharged through the above-mentioned drain port, followed by treatment such as rinsing and drying.

A chamber door 13 is disposed at a front side (left side in FIG. 1) of the casing 2. The chamber door 13 is a box-shaped member having a rectangular parallelepiped shape and is supported in an openable and closable manner by a hinge. The chamber door 11 has a box-like shape in which a front-wall-2a side surface of the casing 2 is opened. An air supply chamber 14 is formed inside the chamber door 13. The air supply chamber 14 is disposed at a front stage of a front opening 7 of the drum 1. A maintenance door 15 is provided in a front surface of the chamber door 13. A monitoring window is provided at the center of the maintenance door 15. A product discharge port 16 for taking a product after treatment is provided at a lower portion of the chamber door 13.

An air supply hole 17 is provided above the front opening 7 of the casing front wall 2a. The air supply hole 17 communicates with an air supply port 19 formed in a casing upper surface 2b through an air supply duct 18 provided in the casing 2. In the coating apparatus 10, when the chamber door 13 is closed, the front opening 7 of the drum 1 faces and communicates with the air supply chamber 14. Air supplied to the air supply port 19 flows into the air supply chamber 14. The air supplied to the air supply chamber 14 is then supplied to the drum 1 through the front opening 7.

A spray gun 21 for spraying coating liquid is inserted through the casing front wall 2a and into the drum 1 through the front opening 7 of the drum 1. The spray gun 21 is mounted to a support holder 22. The spray gun 21 can be taken in and out of the drum 1 through the apparatus front side together with the support holder 22. As the spray gun 21, a sugarcoating spray gun and a film coating spray gun are mounted to the support holder 22.

The support holder 22 is formed of a hollow metal pipe (having a diameter of, e.g., 50 mm). The support holder 22 contains various hoses (not-illustrated, such as a spray air hose, a pattern air hose, a cylinder air hose (needle valve), a liquid hose (supply) a liquid hose (return)) for supplying coating liquid or spraying air to the spray guns 21. In the coating apparatus 10, the liquid and air hoses are provided in a concealed manner and are thus not exposed outside.

An exhaust duct 23 for exhausting air supplied to the drum 1 is connected to the casing 2. A seal duct (not-illustrated) disposed adjacent to the trunk portion 4 of the drum 1 and a connecting duct 24 for connecting the seal duct and the exhaust duct 23 are provided in the casing 2. Air supplied through the chamber door 13 is exhausted from the drum 1 to the seal duct and then outside the apparatus through the connecting duct 24 and exhaust duct 23.

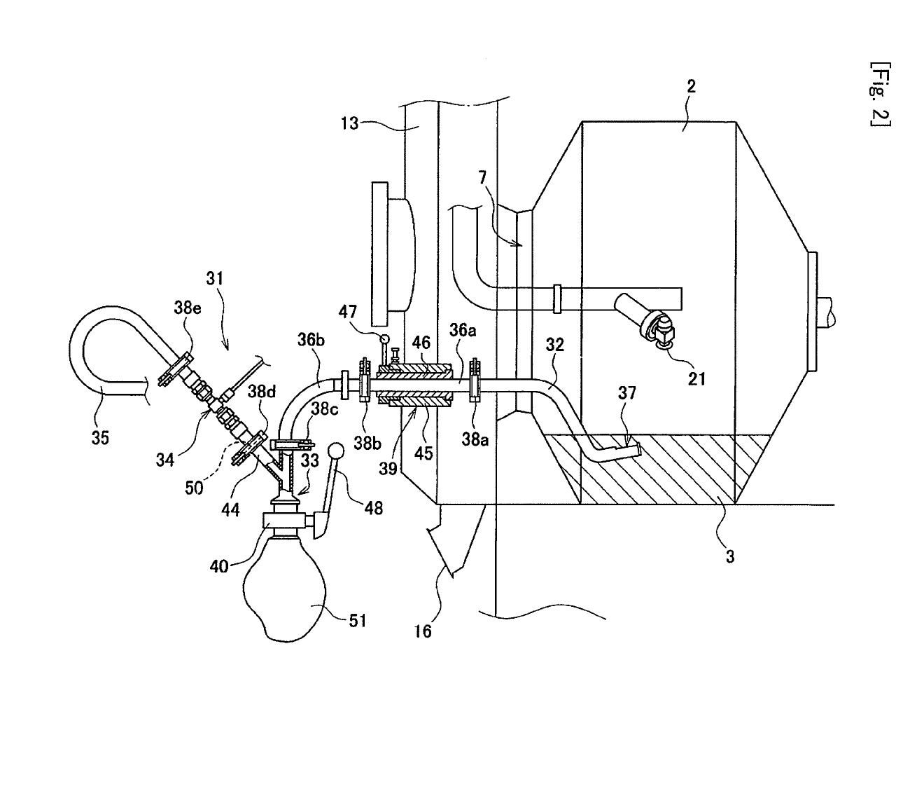

To the pan coating apparatus 10, an automatic sampler 31 is further mounted. FIG. 2 is an explanatory view illustrating a configuration of the automatic sampler 31. The automatic sample 31 is designed to be able to perform sampling of the objects to be processed without opening the apparatus. The automatic sampler 31 is constituted by a sampling pipe 32 extending inside and outside the drum 1, a sample collecting portion 33 connected to the sampling pipe 32 through pipes 36a and 36b, an ejector 34 imparting sample suction action to the sampling pipe 32, and an air return pipe 35 that circulates exhaust air caused by the sample suction action into the drum 1.

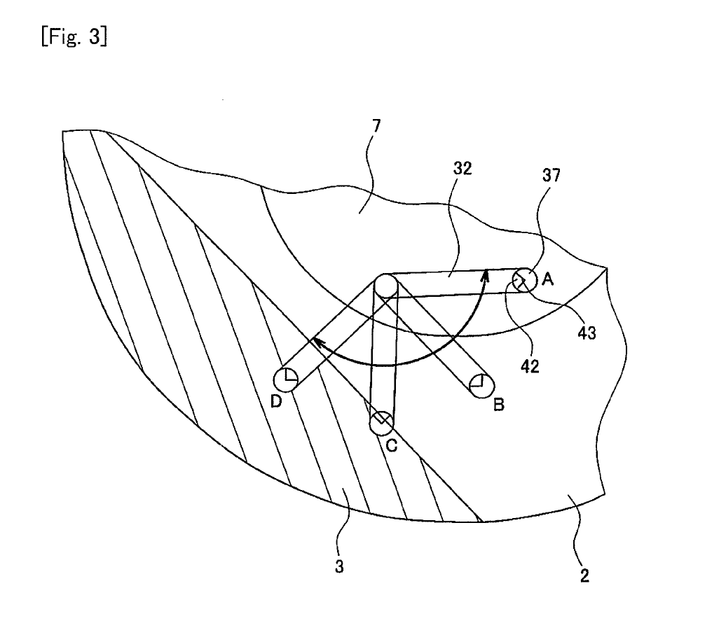

A cut-out shaped sampling portion 37 is provided at a leading end of the sampling pipe 32. As illustrated in FIG. 3, the sampling portion 37 is made to swing by lever operation. The swingable range of the sampling portion 37 includes a drawn position A, a suction position B, a layer of the object to be processed insertion position C, and a pickup position D. When sampling is performed, the sampling portion 37 is made to swing from outside the pan coating apparatus to be inserted into the layer of the object (position D). Then, the sampling portion 37 at the position D is used to scoop out the objects. After the collection of the objects, the sampling portion 37 is moved to the suction position B. Then, the collected objects are sucked by a negative pressure generated by the ejector 34 to be collected in the sample collecting portion 33.

As illustrated in FIG. 2, the sampling portion 37 is disposed in the drum 1. The sampling pipe 32 extends from outside the drum, passes through the front opening 7, and is inserted into the drum 1. The sampling portion 37 is provided at the leading end of the sampling pipe 32. The sampling pipe 32 is connected and fixed to the pipe 36a through a shaft coupling 38a. The pipe 36a passes through a pipe attachment portion 39 and extends outside the chamber door 13. Outside the apparatus, the pipe 36a is rotatably connected to the pipe 36b through a shaft coupling 38b. This allows the sampling pipe 32 and pipe 36a to be rotated with respect to the pipe 36b. As a result, it is possible to rotate the sampling pipe 32 from outside the apparatus to allow the sampling portion 37 to swing between the “drawn position A” to “pickup position D”.

The pipe 36b outside the apparatus is connected, through a shaft coupling 38c, to the sample collecting portion 33 provided with an on-off valve 40. The sample collecting portion 33 is connected, through a shaft coupling 38d, to one end of the ejector 34. The ejector 34 is connected with a compressor 41. The compressor 41 supplies compressed air to the ejector 34. The other end of the ejector 34 is connected, through a shaft coupling 38e, to the air return pipe 35.

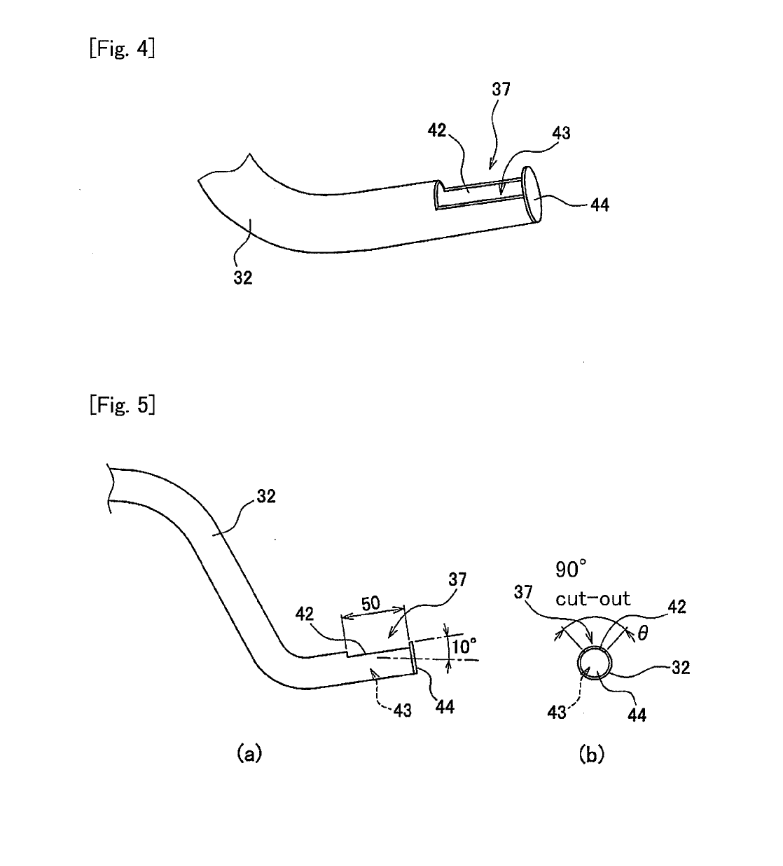

FIG. 4 is a perspective view illustrating a configuration of the sampling portion 37, FIG. 5A is a side view thereof, and FIG. 5B is a front view thereof. As illustrated in FIGS. 4, 5A, and 5B, the sampling portion 37 is formed so as to be bent at the leading end of the sampling pipe 32 (having an inner diameter of about 20 mm). The sampling portion 37 is inclined upward by 10° relative to a horizontal axis. If the sampling portion 37 is not inclined, all the picked up objects to be processed cannot be sucked, and a part thereof may remain in the sampling portion 37, resulting in an unstable sampling amount. On the other hand, if the inclination angle is too large, the sample product cannot be scooped out well from the layer of the object when a preparation amount of the objects is small, resulting in failure to ensure a predetermined sampling amount. Experiments made by the present inventors revealed that the inclination angle of the sampling portion 37 was preferably set in a range from 8° to 12° and most preferably to about 10°. The cut-out portion 42 is formed at a leading end of the sampling portion 37. An inside of the cut-out portion 42 functions as a trapping portion 43. The trapping portion 43 communicates with an inside of the sampling pipe 32. A disk 44 is mounted to the leading end of the sampling portion 37. A leading end side of the cut-out portion 42 is closed by the disk 44. That is, the end portion of the trapping portion 43, including the cut-out portion 42, is closed by the disk 44. The inclination angle of the sampling portion 37 is as small as about 10°.

Thus, when the disk 44 is not formed and the end portion of the trapping portion 43 is opened, the picked up objects to be processed may be dropped from the leading end of the sampling portion 37. Thus, to prevent the drop of the objects, the disk 44 is provided.

The cut-out portion 42 is obtained by cutting an outer peripheral wall of the sampling pipe 32 by a length of 50 mm at an aperture angle θ (see FIG. 5B: center angle of the cut-out portion 42) equal to 90°. If the aperture angle of the cut-out portion 42 is too small, an amount of the objects to be processed that can be scooped out becomes small, resulting in failure to ensure a desired sampling amount. On the other hand, if the aperture angle of the cut-out portion 42 is too large, the objects are dropped from the sampling portion 37 before the suctioning at the suction position B. Experiments made by the present inventors revealed that the aperture angle θ of the cut-out portion 42 was preferably set in a range from 80° to 100° and most preferably to about 90° where even if the scooped out objects to be processed cannot be sucked sufficiently and a part thereof remains in the sampling portion 37, the objects can be dropped into a pan at the drawn position A. Further, when the aperture length of the cut-out portion 42 is too large, suction power is reduced to make it easier for the scooped out objects to remain in the trapping portion 43. Experiments made by the present inventors revealed that the aperture length of the cut-out portion 42 was preferably set in a range from 40 mm to 60 mm and more preferably to about 50 mm.

In the automatic sampler 31 according to the present invention, the above-described cut-out shape is adopted as the sampling portion 37, thereby allowing a certain amount of the sample to be scooped out from the layer of the object. In a system unlike the present invention where a straight-pipe-shaped member having an opened end portion is inserted into the layer followed by suctioning, it is difficult to always collect a certain amount of the sample. The collection amount of the sample varies depending on a length of introduction time of the compressed air into the ejector. However, in negative pressure suctioning, it is very difficult to precisely control the collection amount by controlling the air introduction time. On the other hand, the automatic sampler 31 scoops out the objects by means of the cut-out shaped sampling portion 37. The amount of the sample that can be collected is determined depending on the inner diameter of the trapping portion 43 and size (aperture length) of the cut-out portion 42. Thus, by setting the sampling portion 37 to a predetermined dimension, it is possible to always collect a certain amount of the sample for each operation, thereby allowing a stable sample amount to be ensured.

The pipe attachment portion 39 is provided at the front of the chamber door 13 and below the maintenance door 15 so as to penetrate a front wall of the chamber door 13. The pipe attachment portion 39 includes a cylindrical bracket 45 air-tightly mounted to the chamber door 13 and a sleeve 46 rotatably inserted into the bracket 45. The sleeve 46 is air-tightly mounted to the bracket 45 through an O-ring. The pipe 36a is air-tightly inserted and fixed to the sleeve 46. A rotating lever 47 is mounted to the bracket 45. Operating the rotating lever 47 rotates the pipe 36a to cause the sampling portion 37 to swing between the positions A to D (see FIG. 3) in the drum 1.

The on-off valve 40 is provided in the sample collecting portion 33. The on-off valve 40 is operated using a valve lever 48. A branched pipe 49 extends from a front stage of the on-off valve 40. The branched pipe 49 is connected, through the shaft coupling 38d, to the one end of the ejector 34. A wire mesh 50 is mounted to the shaft coupling 38d. The wire mesh 50 is provided for preventing a sample product (objects to be processed) collected in the sample collecting portion 33 from entering the ejector 34 side. A sampling bag 51 for accommodating the collected objects to be processed is provided below the sample collecting portion 33. When the on-off valve 40 is opened using the valve lever 48, the sample product accumulated in the sample collecting portion 33 is accommodated in the sampling bag 51.

The compressor 41 installed outside the apparatus is connected to the ejector 34. The compressor 41 supplies compressed air to the ejector 34. The other end of the ejector 34 is connected to one end of the air return pipe 35. The other end of the air return pipe 35 is air-tightly mounted to the chamber door 13. The air return pipe 35 communicates with the air supply chamber 14. The compressed air supplied from the compressor 41 to the ejector 34 is distributed in the air supply chamber 14 through the air return pipe 35. As a result, the sample collecting portion 33 assumes a negative pressure, causing the suction power in the sampling portion 37 side through the pipes 36a and 36b and sampling pipe 32.

The following describes coating treatment using the coating apparatus described above, taking production of sugar-coated tablets as an example. First, as the objects 3 to be processed subjected to the coating treatment, tablets (e.g., diameter of 8 mm, 200 mg/T) such as milk sugar tablets are put in the drum 1. In the case of the coating apparatus 10, the objects 3 are put in the drum 1 through the front opening 7 thereof with the chamber door 13 opened. After a predetermined amount of the objects 3 have been put in the drum 1, the spray gun 21 is set in the drum 1. Then, the chamber door 13 is closed, and the drum drive motor is activated to rotate the drum 1.

After that, with the drum 1 being rotated, coating liquid (sugar-coating liquid) is sprayed from the spray gun 21 to the objects 3 in the drum 1. The coating liquid contains coating material, binder, solvent, etc. The coating liquid is sprayed from the spray gun 21 with a predetermined pressure. In the coating apparatus 10, during the spraying of the coating liquid, the automatic sampler 31 is used to perform sampling of the objects 3 where appropriately so as to confirm progress of the granulation and coating.

In the sampling, the rotating lever 47 is operated to move the sampling portion 37 to the pickup position D to introduce the objects 3 into the sampling portion 37. After insertion of the sampling portion 37 into the layer of the object and introduction of the objects 3 into the trapping portion 43, the rotating lever 47 is operated once again to move the sampling portion 37 to the suction position B. Then, with the sampling portion 37 kept at the suction position B, compressed air is supplied from the compressor 41 to the ejector 34.

As described above, when the compressed air is supplied to the ejector 34, the sample collecting portion 33 assumes a negative pressure, causing the suction power to the sample collecting portion 33 in the sampling portion 37. Therefore, with supply of the compressed air, the objects 3 are sucked from the sampling portion 37 and fed to the sample collecting portion 33. After the suctioning, the sampling portion 37 is moved once to the drawn position A, and presence/absence of residues in the trapping portion 43 can be confirmed. Exhaust air caused by the suction action is returned to the air supply chamber 14 through the return air pipe 35. That is, in the automatic sampler 31, sucked air and exhaust air thereof at the sampling do not flow outside the sampler at all. Thus, the sampling of the objects 3 can be accomplished in a complete closed system. The objects 3 that has been sucked and fed to the sample collecting portion 33 are accommodated in the sampling bag 51 by operation of the valve lever 48. The sampling bag 51 accommodating the sampled objects 3 is then removed from the sample collecting portion 33 and passed to an inspection department.

As described above, in the automatic sampler 31 according to the present invention, it is possible to perform the sampling of the objects to be processed in a closed system, eliminating the need to manually collect the sample. Further, it is possible to meet containment requirements without using an isolator. Thus, in a pan coating apparatus, automatic sample collection can be performed with safety and ease, thereby eliminating the need for excessive facility investment. Further, the sampling can be performed without interruption to thereby improve work efficiency of coating treatment.

After the objects 3 are sampled in this manner, a state of the objects 3 is checked, and treatment conditions are adjusted based on a result of the check.

When it is determined that a desired coating layer is formed on each of the objects 3, the coating treatment is ended. After the completion of the coating treatment, the product discharge port 16 of the coating apparatus 10 is opened. Subsequently, with the spray gun 21 and automatic sampler 31 kept unchanged and with the chamber door 13 kept closed, the drum 1 is rotated in a direction reverse to that in the coating treatment. When the drum is rotated in this direction, a coated product is discharged outside the apparatus through the air supply chamber 14 by a not-illustrated reverse-discharge guide, whereby the coating work by the coating apparatus 10 is ended.

The present invention is not limited to the above-described embodiment, but may be variously modified within the scope of the invention.

For example, the above numerical values are given merely for illustrative purposes and they may be changed as needed. Further, in the above embodiment, the objects 3 are collected in the layer of the object, and then the sampling portion 37 is moved to the suction position B for suctioning. Alternatively, however, the suctioning may be performed with the sampling portion 37 remaining inserted into the layer (with the sampling portion 37 remaining at a position between the insertion position C and pickup position D). Further, the automatic sampler according to the present invention may be applied not only to a pan coating apparatus such as the coating apparatus 10, but also to a fluidized bed granulation coating apparatus provided with an erect cylindrical processing vessel. In addition, the objects to be collected by the automatic sampler 31 are not limited to the tablets such as milk sugar tablets, but may be food such as sweets or chewing gums or drugs and medicines.

What is claimed is:

1. An automatic sampler mounted to a granulation coating apparatus that performs processings such as granulation, coating, drying and mixing of powder and particle in a processing vessel provided therein, the sampler comprising:
a sampling pipe that has one end disposed in the processing vessel and the other end extending outside the processing vessel;
a sampling portion that is formed at a leading end of the one end of the sampling pipe and moves in the processing vessel so as to pickup a sample of objects to be processed from a layer of the object to be processed of the powder and particle;
a depressurization source that imparts sample suction action brought about by depressurization to the sampling pipe;
a sample collecting portion that is provided between the other end of the sampling pipe and depressurization source and accommodates the sample of the objects to be processed sucked from the sampling portion; and
an air return pipe that has one end connected to the depressurization source and the other end communicating with an inside of the processing vessel and circulates exhaust air caused by the sample suction action into the processing vessel.

2. The automatic sampler according to claim 1, wherein
the sampling portion is formed so as to be bent at the leading end of the sampling pipe and inclined relative to a horizontal axis.

3. The automatic sampler according to claim 1, wherein
the sampling portion swings between a pickup position and a suction position by rotation of the sampling pipe, and
the sampling portion is inserted into the layer of the object to be processed at the pickup position to introduce the objects to be processed therein and moves away from the layer of the object to be processed at the suction position to allow the objects to be processed introduced therein to be sucked to the sample collecting portion side.

4. The automatic sampler according to claim 3, wherein
when moving from the pickup position to the suction position, the sampling portion scoops out the objects to be processed in the layer of the object to be processed and introduces them therein.

5. The automatic sampler according to claim 1, wherein
the sampling portion has a cut-out portion obtained by cutting a peripheral wall of the sampling pipe and a trapping portion provided inside the cut-out portion so as to communicate with an inside of the sampling pipe, and
the objects to be processed are introduced from the cut-out portion into the trapping portion to trap the sample of the objects to be processed.

6. The automatic sampler according to claim 1, wherein
the processing vessel is a rotating drum provided so as to be able to rotate about substantially a horizontal rotating axis.

7. The automatic sampler according to claim 2, wherein
the sampling portion is inclined by 8° to 12° relative to the horizontal axis.

8. The automatic sampler according to claim 5, wherein
an aperture angle θ of the cut-out portion is 80° to 100°.
